(19) United States
(12) Patent Application Publication
(10) Pub. No.: US 2026/0036926 A1
(43) Pub. Date: Feb. 5, 2026

(54) ELECTROPHOTOGRAPHIC MEMBER, ELECTROPHOTOGRAPHIC IMAGE FORMING APPARATUS AND METHOD OF PRODUCING ELECTROPHOTOGRAPHIC MEMBER

(71) Applicant: CANON KABUSHIKI KAISHA, Tokyo (JP)

(72) Inventors: MASAHIRO TAKENAGA, Kanagawa (JP); NAOKO KASAI, Kanagawa (JP); MASATSUGU TOYONORI, Kanagawa (JP); YASUTOMO TSUJI, Saitama (JP); YUJI KITANO, Kanagawa (JP); SHOHEI ISHIO, Tokyo (JP)

(21) Appl. No.: 19/277,594

(22) Filed: Jul. 23, 2025

(30) Foreign Application Priority Data
Jul. 31, 2024 (JP) 2024-124802
Apr. 23, 2025 (JP) 2025-071298

(51) Int. Cl. G03G 15/16

(52) U.S. Cl. CPC G03G 15/162; G03G 2215/1623

(57) ABSTRACT

An electrophotographic member having a base layer and a surface layer in direct contact with the base layer is provided, in which the surface layer contains heteroaggregates of first particles and second particles different from the first particles, the first particles are chain-like inorganic oxide particles, the second particles contain a conductive metal oxide, the number-average particle diameter of primary particles is 5 to 40 nm, the surface layer has protruded portions derived from the heteroaggregates on an outer surface thereof opposite to a surface that faces the base layer, an arithmetic mean height (Sa) of the outer surface is 0.1 to 0.7 μm, and the base layer contains specific cations and anions.

### BACKGROUND

### Field of the Technology

The present disclosure relates to an electrophotographic member, an electrophotographic image forming apparatus and a method of producing an electrophotographic member.

### Description of the Related Art

In electrophotographic image forming apparatuses, electrophotographic belts are used as transport/transfer belts for transporting transfer materials and as electrophotographic members that temporarily transfer and hold toner images. The electrophotographic belt comes into contact with and slides against other members in the electrophotographic image forming apparatus, and if the surface of the electrophotographic belt is excessively smooth, adhesion thereof to other members may occur.

For example, if a photosensitive drum or a cleaning blade adheres to the surface of the electrophotographic belt, stable rotation of the electrophotographic belt may be inhibited. A decrease in the rotation stability of the electrophotographic belt may cause, for example, an unstable moving speed of the electrophotographic belt, which may result in deviations when toner images of colors are transferred onto paper. Thus, in order to prevent other members from adhering to the outer surface of the electrophotographic belt, the surface of the electrophotographic belt has conventionally been roughened.

As a method for roughening the surface of an electrophotographic belt, Japanese Patent Publication No. 2014-146024 discloses heteroaggregation of inorganic oxide particles having a particle diameter of 10 to 30 nm and conductive metal oxide particles having a particle diameter of 5 to 40 nm in the presence of alkali metal ions. Thus, protruded portions derived from heteroaggregates are formed. Specifically, a base layer of the electrophotographic belt contains an alkali metal salt of perfluoroalkylsulfonic acid or an alkali metal salt of perfluoroalkyl sulfonimides. Then, a curable composition containing the inorganic oxide particles, the conductive metal oxide particles, acrylic monomers, and a solvent is applied onto the base layer, and in a step of drying the solvent in the curable composition, alkali metal ions in the base layer are transferred to the surface layer to cause heteroaggregation.

Japanese Patent Publication No. 2014-146024 discloses the invention in which, when particles having a small particle diameter are used as particles per se used for roughening, the surface of the surface layer is roughened because heteroaggregates of particles having a small particle diameter are formed while the formation of specifically large protrusions is prevented.

### SUMMARY

At least one aspect of the present disclosure is to provide an electrophotographic member that uses a material not PFAS-related and can restrict adhesion to other members. In addition, at least one aspect of the present disclosure is to provide a method of producing an electrophotographic member that uses a material not PFAS-related and can restrict adhesion to other members. In addition, at least one aspect of the present disclosure is to provide an electrophotographic image forming apparatus that can stably form high-quality electrophotographic images.

At least one aspect of the present disclosure provides an electrophotographic member comprising a base layer and a surface layer in direct contact with the base layer, wherein the surface layer comprises heteroaggregates of first particles and second particles different from the first particles, the first particles are chain-like inorganic oxide particles, the second particles comprise a conductive metal oxide, and a number-average particle diameter of primary particles of the second particles is 5 to 40 nm, the surface layer has protruded portions derived from the heteroaggregates on an outer surface thereof opposite to a surface that faces the base layer, an arithmetic mean height (Sa) of the outer surface is 0.1 to 0.7 μm, the base layer comprises at least one cation selected from the group consisting of cations represented by following Formulae (C1) to (C4) and at least one anion selected from the group consisting of anions represented by following Formulae (A1) to (A4).

In addition, at least one aspect of the present disclosure provides a method of producing an electrophotographic member having a base layer and a surface layer in direct contact with the base layer, the production method comprising: preparing a base layer comprising component (e) below; preparing a curable composition comprising component (a) to component (d) below; forming a coating of the curable composition on one of surfaces of the base layer and drying the coating; and curing the dried coating: (a) first particles that are chain-like inorganic oxide particles; (b) second particles that are different from the first particles, and have a number-average particle diameter of primary particles of 5 to 40 nm, and comprise a conductive metal oxide; (c) (meth)acrylic monomers; (d) at least one solvent selected from the group consisting of 2-butanone and 4-methyl-2-pentanone; (e) a salt containing at least one cation selected from the group consisting of cations represented by following Formulae (C1) to (C4) and at least one anion selected from the group consisting of anions represented by following Formulae (A1) to (A4):

In addition, at least one aspect of the present disclosure provides an electrophotographic image forming apparatus comprising the above-mentioned electrophotographic member as an intermediate transfer belt.

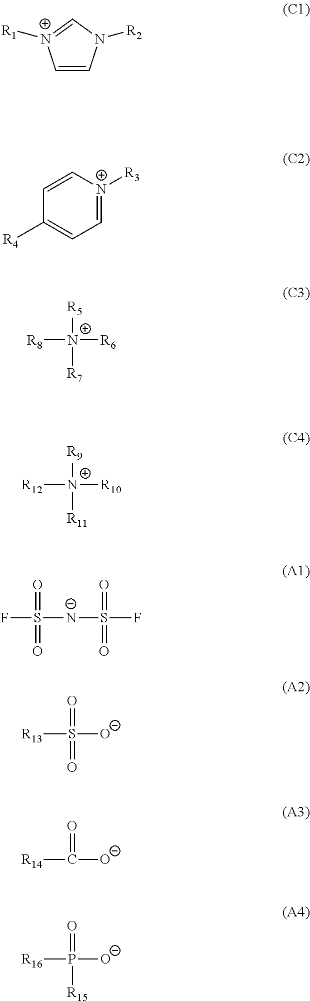

R₁ to R₁₂ are each independently a hydrogen atom or a hydrocarbon group having 1 to 14 carbon atoms, provided that at least one selected from the group consisting of R₁ and R₂, at least one selected from the group consisting of R₃ and R₄, at least one selected from the group consisting of R₅ to R₈, and at least one selected from the group consisting of R₉ to R₁₂ are a linear or branched alkyl group having 1 to 14 carbon atoms; and R₁₃ to R₁₆ are each independently a hydrogen atom, a hydrocarbon group having 1 to 18 carbon atoms, or an alkoxy group having 1 to 18 carbon atoms.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic cross-sectional view of an electrophotographic belt.

FIG. 2 is a diagram illustrating an electrophotographic image forming apparatus.

FIG. 3 is a schematic view of a jig for evaluating adhesion between an electrophotographic belt and other members.

FIG. 4 is a diagram illustrating the height of protruded portions derived from base layer particles.

### DESCRIPTION OF THE EMBODIMENTS

In the present disclosure, “from XX to YY” or “XX to YY” indicating a numerical range means a numerical range including a lower limit and an upper limit that are end points unless otherwise specified. In a case where numerical ranges are described in stages, an upper limit and a lower limit of each numerical range can be combined as desired. Furthermore, in the present disclosure, for example, description such as “at least one selected from the group consisting of XX, YY, and ZZ” means any of XX, YY, ZZ, a combination of XX and YY, a combination of XX and ZZ, a combination of YY and ZZ, or a combination of XX, YY, and ZZ. When XX is a group, multiple XXs may be selected from the group, and the same applies to YY and ZZ.

In recent years, restrictions on the use of perfluoroalkyls and polyfluoroalkyl substances (hereinafter referred to as “PFAS”), which are considered to have high environmental persistence and bioaccumulation, have been studied. In Japanese Patent Publication No. 2014-146024, anions having C-F bonds in the molecule are used, and the salt described in Japanese Patent Publication No. 2014-146024 may not be able to be used due to restrictions. Therefore, the inventors studied the formation of protruded portions on the surface of the surface layer even if the base layer contains salts of anions that do not have C-F bonds in the molecule and are not PFAS-related and alkali metal cations.

The inventors formed a surface layer by applying a surface-layer-forming coating material in Japanese Patent Publication No. 2014-146024 onto the base layer containing salts of anions not PFAS-related (hereinafter referred to as “non-PFAS anions”) and alkali metal cations. However, heteroaggregation of the particles disclosed in Japanese Patent Publication No. 2014-146024, that is, inorganic oxide particles having an average primary particle diameter of 10 to 30 nm and conductive metal oxide particles having an average primary particle diameter of 5 to 40 nm, is unlikely to occur and it is difficult to form a rough surface having an arithmetic mean height Sa of 0.1 to 0.7 μm on the outer surface of the surface layer.

The reason why heteroaggregation is unlikely to occur when the base layer contains salts of non-PFAS anions and alkali metal cations is inferred to be as follows. The non-PFAS anions have localized negative charges and thus bind strongly to alkali metal cations, and salts of non-PFAS anions and alkali metal cations have a low ion dissociation degree. Therefore, it is inferred that transfer of alkali metal cations from the base layer to the surface layer does not occur sufficiently, and heteroaggregates are not formed.

Therefore, the inventors conducted extensive studies for the purpose of roughening the outer surface of the surface layer using heteroaggregates, assuming the use of salts containing non-PFAS-based anions and cations. In the course of the studies, the inventors first studied use of specific organic cations having a larger size than alkali metal cations as cations to be combined with non-PFAS-based anions, based on the above consideration.

Specifically, the use of at least one cation selected from the group consisting of the following Formulae (C1) to (C4) has been studied. This is intended to increase the degree of dissociation of the ionic conducting agent by increasing the distance between anions and cations, and weakening the Coulomb force.

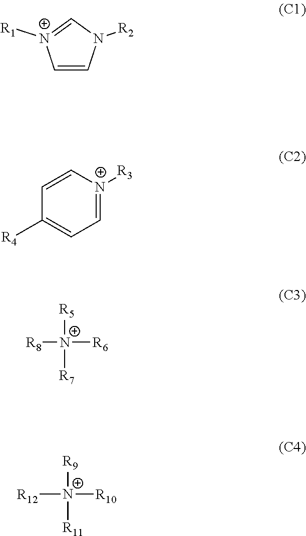

In Formulae (C1) to (C4), R₁ to R₁₂ are each independently a hydrogen atom or a hydrocarbon group having 1 to 14 carbon atoms.

However, the ability of the ionic conducting agent containing the above cations and non-PFAS anions to form heteroaggregates is limited. The reason for this is thought to be that the above organic cations have a larger molecular weight than alkali metal cations and thus have a small surface charge density.

Therefore, the inventors studied an optimal combination of first particles and second particles, which can form heteroaggregates having an appropriate size even if the ionic conducting agent is composed of non-PFAS-based anions and the above organic cations. As a result, the inventors found that a combination of the following ionic conducting agent, first particles, and second particles makes it possible to stably form protruded portions on the outer surface of the surface layer according to heteroaggregates of the first particles and second particles. As a result, a rough surface having an arithmetic mean height (Sa) of 0.1 to 0.7 μm can be formed on the outer surface of the surface layer.

### Ionic Conducting Agent

The ionic conducting agent (salt) contains at least one cation selected from the group consisting of cations represented by the following Formulae (C1) to (C4) and at least one anion selected from the group consisting of anions represented by the following Formulae (A1) to (A4).

### Anion

At least one anion selected from the group consisting of anions represented by the following Formulae (A1) to (A4):

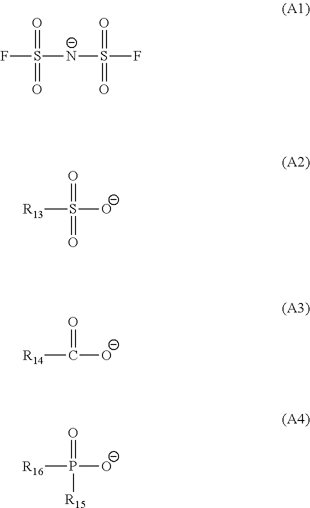

R₁₃ to R₁₆ are each independently a hydrogen atom, a hydrocarbon group having 1 to 18 carbon atoms, or an alkoxy group having 1 to 18 carbon atoms.

### Cation

At least one cation selected from the group consisting of cations represented by the following Formulae (C1) to (C4).

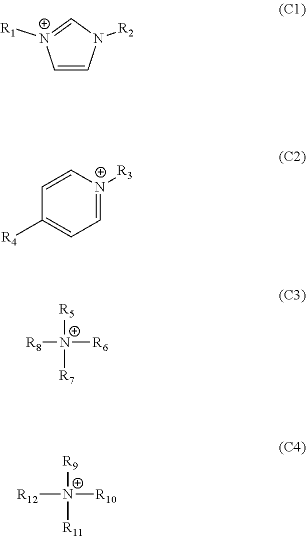

R₁ to R₁₂ are each independently a hydrogen atom or a hydrocarbon group having 1 to 14 carbon atoms. However, at least one selected from the group consisting of R₁ and R₂, at least one selected from the group consisting of R₃ and R₄, at least one selected from the group consisting of R₅ to R₈, and at least one selected from the group consisting of R₉ to R₁₂ are a linear or branched alkyl group having 1 to 14 carbon atoms.

At least one selected from the group consisting of R₁ and R₂ is preferably a linear or branched alkyl group having 1 to 3 carbon atoms. In addition, at least one selected from the group consisting of R₃ and R₄ is preferably a linear or branched alkyl group having 1 to 10 carbon atoms. In addition, at least one selected from the group consisting of R₅ to R₈, and at least one selected from among R₉ to R₁₂ are preferably a linear or branched alkyl group having 4 to 14 carbon atoms.

### First Particles

The first particles are chain-like inorganic oxide particles.

### Second Particles

The second particles are particles different from the first particles. The second particles contain a conductive metal oxide, and the number-average particle diameter of primary particles of the second particles is 5 to 40 nm.

Hereinafter, an embodiment of an electrophotographic belt will be described in detail as an exemplary embodiment of an electrophotographic member. Here, the present disclosure may be other electrophotographic members such as an electrophotographic roller and is not limited to the following embodiment.

The outer surface of the surface layer can be roughened by, for example, the following method, such that it has an arithmetic mean height (Sa) of 0.1 to 0.7 um. An ionic conducting agent (salt) containing the non-PFAS anions and the above cations is incorporated into the base layer, and a coating of a surface-layer-forming composition containing the above first particles and the above second particles is formed on the base layer. A small amount of the cations transfers from the base layer into the coating of the surface-layer-forming composition, and an increase in the cation concentration in the coating in the process of drying the coating can cause the first particles and the second particles to aggregate (heteroaggregate) in the coating. In the process of drying the coating, the cation concentration in the coating increases, the charges of the first particles and the second particles in the coating become opposite polarities, and heteroaggregates are formed. Thereby, protruded portions derived from heteroaggregates can be formed on the surface of the surface layer, and roughening can be achieved such that the Sa is within the above range.

Here, the protruded portions derived from the heteroaggregates include, for example, at least one selected from the group consisting of protruded portions formed by exposing at least some of the heteroaggregates on the surface of the surface layer and protruded portions formed by coating the surface of the heteroaggregates with a matrix resin in the surface layer.

By roughening the surface such that the arithmetic mean height (Sa) is in a range of 0.1 to 0.7 μm, it is possible to restrict adhesion to other members. The arithmetic mean height (Sa) of the surface of the surface layer is preferably 0.1 to 0.6 μm.

The arithmetic mean height (Sa) of the surface of the surface layer can be, for example, adjusted by adjusting at least one element selected from the group consisting of the particle diameter of the first particles, the particle diameter of the second particles, the amount of the first particles, the amount of the second particles, and the amount of the ionic conducting agent.

As an example of an electrophotographic member according to the present disclosure, an electrophotographic belt will be described.

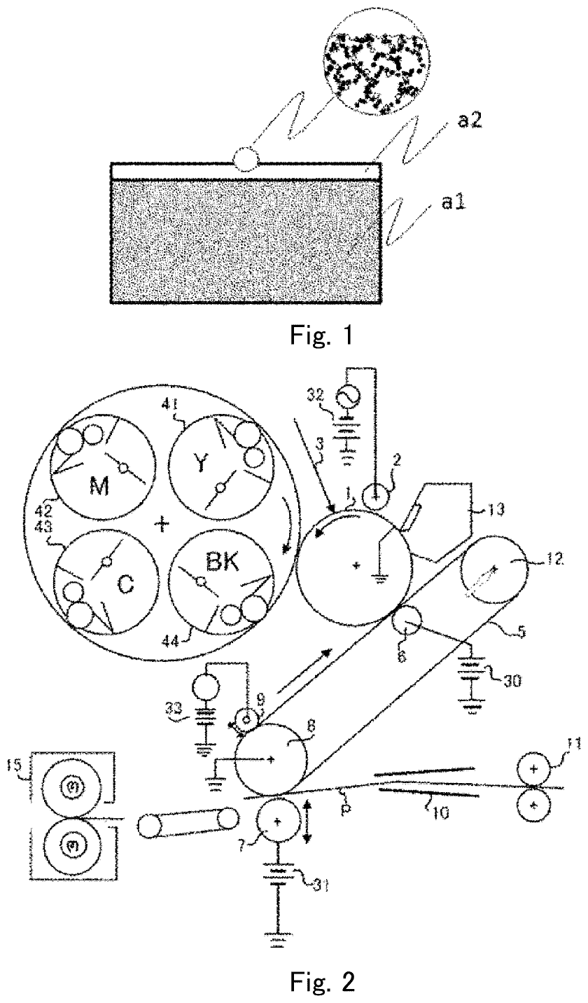

FIG. 1 is a conceptual cross-sectional view of an electrophotographic belt. The electrophotographic belt has an electrophotographic seamless belt base layer a1 and a surface layer a2 in direct contact with the base layer.

The thickness of the base layer is not particularly limited, and is 10 μm to 500 μm, particularly 30 μm to 150 μm, and more preferably 50 μm to 100 μm. The thickness of the surface layer is not particularly limited, and is 0.05 μm to 20 μm, particularly 0.1 μm to 5 μm, and more preferably 1 μm to 3 μm.

### Curable Composition

The surface layer can be, for example, a cured product of the following curable composition.

### Constituent Components of Curable Composition

Examples of constituent components of the curable composition for forming the surface layer are as follows. The curable composition contains a component (a) and a component (b), and preferably contains a component (a), a component (b), a component (c) and a component (d).

### Component (a) (First Particles)

The first particles are chain-like inorganic oxide particles.

The chain-like particles are an aggregate of particles in which a plurality of particles are connected in a linear or curved manner. The shape of each particle that makes up the chain-like particles may be clearly observed or the particles may melt and be adhered together and lose their shapes.

In the action with the second particles to be described below, the spherical particles form point contacts, but the chain-like particles form multi-point contacts, and thus the action of the second particles and the first particles is easily caused, and the protruded portions derived from the heteroaggregates are easily formed on the surface of the surface layer.

The chain-like particles are randomly shaped particles with a short diameter and a long diameter. The short diameter of the chain-like particles corresponds to the average particle diameter of the primary particles. In addition, the long diameter of the chain-like particles corresponds to the Feret diameter of the secondary particles. The number average value of the long diameters of the first particles is preferably 30 to 100 nm and more preferably 40 to 80 nm. In addition, the number average value of the value ratio of the long diameter to the short diameter of the first particles (long diameter/short diameter) is preferably 3 to 8, more preferably 4 to 7, and still more preferably 4 to 6.

When the values of the long diameter and the long diameter/the short diameter of the first particles are set to be within the above ranges, the dispersion state in the curable composition (liquid) can be stabilized, and even when the curable composition is stored for a long period of time and then used to form a surface layer, it is possible to stably provide a surface layer having sufficient heteroaggregates on the outer surface.

The inorganic oxide particles are preferably silica particles because they are stably dispersed in an organic solvent and are negatively charged. The first particles are preferably chain-like silica particles.

The first particles can be used without a surface treatment, but the first particles may be subjected to a surface treatment with a silane coupling agent or the like.

Here, the method of producing chain-like particles is not particularly limited, and known methods may be used. As the first particles, for example, commercial products such as chain-like silica particles “IPA-ST-UP” (product name; commercially available from Nissan Chemical Corporation) may be used.

### Component (b) (Second Particles)

The second particles different from the first particles include conductive metal oxide particles having a number-average particle diameter of primary particles of 5 to 40 nm.

When the electrophotographic member is used as, for example, an intermediate transfer belt, the surface layer is required to be semi-conductive. Therefore, conductive metal oxide particles are used as the second particles.

The number-average particle diameter of primary particles of the second particles is 5 to 40 nm, preferably 5 to 25 nm, and more preferably 15 to 25 nm. When the number-average particle diameter of primary particles of the second particles is set to be within the above range, it is possible to prevent formation of singular points (bumps) on the outer surface of the surface layer. In addition, the dispersion state in the curable composition (liquid) can be stabilized, and even when the curable composition is stored for a long period of time and then used to form a surface layer, it is possible to stably obtain a surface layer having an outer surface with an Sa of 0.1 to 0.7 μm. The second particles may be subjected to a surface treatment in order to improve the dispersion stability in an organic solvent. In addition, a combination of two or more particles may be used as the conductive metal oxide particles.

The second particles preferably include at least one particle selected from the group consisting of zinc antimonate particles and antimony-doped tin oxide particles (ATO particles). As the second particles, commercial products may be used. For example, CELL NAX CX-Z410K (product name) and CELL NAX CX-Z400K (product name) (commercially available from Nissan Chemical Corporation) may be used as commercially available conductive metal oxide particle slurries. In addition, a slurry prepared from conductive metal oxide particles (product name: SN-100P, commercially available from Ishihara Sangyo Kaisha, Ltd.) may be used.

### Component (c)

Monomers of Matrix Resin;

The surface layer preferably contains a matrix resin. That is, the surface layer preferably contains heteroaggregates of the first particles and the second particles in the matrix resin.

The matrix resin is not particularly limited, and known resins used in the surface layer of the electrophotographic member such as an intermediate transfer belt can be used. The matrix resin preferably includes at least (meth)acrylic resin because this provides excellent scratch resistance to the outer surface of the surface layer. In this case, the curable composition used to form the surface layer preferably contains monomers that form a matrix resin, for example, (meth)acrylic monomers.

The (meth)acrylic monomers are not particularly limited, and in consideration of the abrasion resistance and hardness, polyfunctional (meth)acrylic monomers are preferable, and examples of suitable monomers include pentaerythritol tri(meth)acrylate, pentaerythritol tetra(meth)acrylate, trimethylolpropane tri(meth)acrylate, EO modified trimethylolpropane tri(meth)acrylate, PO modified trimethylolpropane tri(meth)acrylate, dipentaerythritol penta- and hexa(meth)acrylate, and isocyanuric acid EO modified di- and tri(meth)acrylate. The acrylic monomers particularly preferably include dipentaerythritol penta-and hexa(meth)acrylate. Here, it is also possible to use a plurality of acrylic monomers for curing shrinkage and viscosity adjustment.

In addition, commercial products, for example, ARONIX M-305 (product name, commercially available from Toagosei Co., Ltd.), can be used.

Here, the content of the matrix resin in the surface layer based on the mass of the surface layer is preferably 60.0 to 85.0 mass % and more preferably 65.0 to 80.0 mass %.

### Component (d)

Solvent;

In order to stably disperse or dissolve the above component (a), component (b), and component (c), as well as a component (e) to be described below, the curable composition preferably contains a solvent. The solvent preferably contains at least one selected from the group consisting of 2-butanone and 4-methyl-2-pentanone.

Here, for evaporation rate adjustment and viscosity adjustment, a plurality of solvents other than the above solvents can also be added. Specific examples include the following examples.

Alcohols such as methanol, ethanol, isopropanol, butanol, and octanol; ketones such as acetone and cyclohexanone; esters such as ethyl acetate, butyl acetate, ethyl lactate, γ-butyrolactone, propylene glycol monomethyl ether acetate, and propylene glycol monoethyl ether acetate; ethers such as ethylene glycol monomethyl ether and diethylene glycol monobutyl ether, and aromatic hydrocarbons such as benzene, toluene, and xylene; and amides such as dimethylformamide, dimethylacetamide, and N-methylpyrrolidone.

Among these, methyl isobutyl ketone, methyl ethyl ketone, cyclohexanone, propylene glycol monomethyl ether acetate, propylene glycol monoethyl ether acetate, toluene, xylene and the like are preferable.

The surface-layer-forming curable composition containing the component (a) and the component (b), and preferably containing the components (a) to (d), may contain the following component (e) as necessary.

### Component (e) (Ionic Conducting Agent)

When particles having a relatively large average primary particle diameter which can form a rough surface with an Sa of 0.1 to 0.7 μm on the outer surface of the surface layer are incorporated into a surface-layer-forming coating material, it is difficult to avoid the formation of specific protrusions due to aggregation of the particles in the coating material. On the other hand, in the present disclosure, chain-like inorganic oxide particles and second particles that are too small to achieve an Sa within the above range are hetero-aggregated by the action of the ionic conducting agent. When protruded portions are formed on the surface of the surface layer by the heteroaggregates, it is possible to prevent the formation of specific protrusions on the outer surface of the surface layer and to achieve stable roughening.

Thus, heteroaggregation of the first particles and the second particles can be achieved, for example, by the action of the component (e). For example, a coating of the curable composition is formed on a base layer containing the following component (e), and in the process of drying the coating, at least a part of the cation component of the ionic conducting agent is transferred from the base layer into the coating. Thus, as the solvent in the coating evaporates, the cation concentration in the coating increases, the charges of the first particles and the second particles in the coating become opposite polarities, and heteroaggregates are formed.

Here, the component (e) can be incorporated into the base layer as described above, and heteroaggregates can be generated in the coating by transferring cations from the base layer to the coating on the base layer, but the present invention is not limited thereto. The curable composition may contain the component (e) as one component, and the component (e) may be incorporated into both the base layer and the curable composition. However, in order to prolong the lifespan of the curable composition as the surface-layer-forming coating material, it is preferable that the curable composition do not contain the component (e).

The component (e) contains at least one cation selected from the group consisting of cations represented by Formulae (C1) to (C4) and at least one anion selected from the group consisting of anions represented by Formulae (A1) to (A4). Formulae (C1) to (C4) and Formulae (A1) to (A4) are as described above.

In order to form heteroaggregates, it is preferable that anions and cations be sufficiently ionically dissociated. However, since the anions represented by Formulae (A1) to (A4) are non-PFAS anions and have localized negative charges, salts containing the anions represented by Formulae (A1) to (A4) are generally less likely to dissociate with cations than PFAS anions. Examples of cations that undergo ion dissociation even with non-PFAS anions include cations represented by Formulae (C1) to (C4).

The cations represented by Formulae (C1) to (C4) will be described in detail.

In Formulae (C1) to (C4), R₁ to R₁₂ are each independently a hydrogen atom or a hydrocarbon group having 1 to 14 carbon atoms. However, at least one selected from the group consisting of R₁ and R₂, at least one selected from the group consisting of R₃ and R₄, at least one selected from the group consisting of R₅ to R₈, and at least one selected from the group consisting of R₉ to R₁₂ are a linear or branched alkyl group having 1 to 14 carbon atoms.

Examples of hydrocarbon groups include linear or branched saturated hydrocarbon groups, linear or branched unsaturated hydrocarbon groups, substituted or unsubstituted saturated alicyclic hydrocarbon groups, substituted or unsubstituted unsaturated alicyclic hydrocarbon groups, and substituted or unsubstituted aromatic hydrocarbon groups.

Preferable examples of R₁ and R₂ are each independently, for example, a linear or branched alkyl group having 1 to 8 (more preferably 1 to 4, and still more preferably 1 to 3) carbon atoms.

Preferable examples of R₃ and R₄ are each independently, for example, a linear or branched alkyl group having 1 to 8 (more preferably 1 to 4) carbon atoms.

Preferable examples of R₅ to R₈ are each independently, for example, a linear or branched alkyl group having 1 to 10 carbon atoms.

Preferable examples of R₉ to R₁₂ are each independently, for example, a linear or branched alkyl group having 4 to 14 carbon atoms.

Specific examples of imidazolium-based cations represented by Formula (C1) are as follows.

1-Ethyl-3-methylimidazolium cation, 1-butyl-3-methylimidazolium cation, 1-hexyl-3-methylimidazolium cation, 1-octyl-3-methylimidazolium cation, and 1-octyl-3-methylimidazolium cation.

Specific examples of pyridinium-based cations represented by Formula (C2) are as follows.

1-Ethylpyridinium ions, 1-butylpyridinium ions, 1-hexylpyridinium ions, 1-octylpyridinium ions, 1-(tert-butyl) pyridinium ions, 1-octyl-4-methylpyridinium ions, and 1-octyl-4-butylpyridinium ions.

Specific examples of quaternary ammonium cations represented by Formula (C3) are as follows.

Ammonium ions, trimethylpropylammonium ions, tributylmethylammonium ions, tetraethylammonium ions, tributylethylammonium ions, methyltrioctylammonium ions, methyltridodecylammonium ions, and trihexyltetradecylammonium ions. More preferably, tributylmethylammonium ions, and tributylethylammonium ions.

Specific examples of phosphonium cations represented by Formula (C4) are as follows.

Phosphonium ions, trimethylpropyl phosphonium ions, tributylmethyl phosphonium ions, tetraethyl phosphonium ions, tributylethyl phosphonium ions, methyltrioctyl phosphonium ions, methyltridodecylphosphonium ions, and trihexyltetradecylphosphonium ions. More preferably, trihexyltetradecylphosphonium ions.

The anions may be non-PFAS anions that do not have C-F bonds, and specifically, anions represented by Formulae (A1) to (A4) can be used.

The anions represented by (A1) to (A4) will be described in detail.

The anions represented by Formula (A1) are fluorosulfonylimide anions that do not have C-F bonds in the molecule and are not PFAS-related.

In (A2) to (A4), R₁₃ to R₁₆ are each independently a hydrogen atom, a hydrocarbon group having 1 to 18 carbon atoms, or an alkoxy group having 1 to 18 carbon atoms. Examples of hydrocarbon groups include linear or branched saturated hydrocarbon groups, linear or branched unsaturated hydrocarbon groups, substituted or unsubstituted saturated alicyclic hydrocarbon groups, substituted or unsubstituted unsaturated alicyclic hydrocarbon groups, and substituted or unsubstituted aromatic hydrocarbon groups.

Preferable examples of R₁₃ include a hydrogen atom, a linear or branched alkyl group having 1 to 6 carbon atoms (more preferably 1 to 3 carbon atoms) and a substituted or unsubstituted aryl group (specifically, for example, an unsubstituted phenyl group or a phenyl group substituted with an alkyl group having 1 to 3 carbon atoms (more preferably 1 or 2 carbon atoms)).

Preferable examples of R₁₄ include an alkyl group having 3 to 15 carbon atoms (more preferably 6 to 12 carbon atoms).

Preferable examples of R₁₅ and R₁₆ are each independently a linear or branched alkyl group having 3 to 15 carbon atoms (more preferably 6 to 12 carbon atoms). Specific examples of anions represented by Formula (A2) are as follows.

Sulfonate ions, methanesulfonate ions, ethanesulfonate ions, 1-butanesulfonate ions, p-toluenesulfonate ions (osylate ions), 1-octanesulfonate ions, 1-decanesulfonate ions, 1-tetradecanesulfonate ions, 1-octadecanesulfonate ions, hydrogen sulfate ions, methyl sulfate ions, ethyl sulfate ions, 1-butyl sulfate ions, 1-octyl sulfate ions, 1-decyl sulfate ions, 1-tetradecyl sulfate ions, and 1-octadecyl sulfate ions. More preferably, methanesulfonate ions, ethanesulfonate ions, p-toluenesulfonate ions, and hydrogen sulfate ions.

Specific examples of anions represented by Formula (A3) are as follows.

Methanoate ions, ethanoate ions, butanoate ions, hexanoate ions, benzoate ions, octanoate ions, decanoate ions, dodecanoate ions, tetradecanoate ions, hexadecanoate ions, octadecanoate ions, methyl carbonate ions, ethyl carbonate ions, butyl carbonate ions, hexyl carbonate ions, octyl carbonate ions, decyl carbonate ions, tetradecyl carbonate ions, and octadecyl carbonate ions. More preferably, decanoate ions.

Specific examples of anions represented by Formula (A4) are as follows.

Phosphinate ions, dimethylphosphinate ions, ethylmethylphosphinate ions, diethylphosphinate ions, dibutylphosphinate ions, bis(2,4,4-trimethylpentyl)phosphinate ions, dioctylphosphinate ions, ditetradecylphosphinate ions, dioctadecylphosphinate ions, dimethyl phosphate ions, diethyl phosphate ions, dibutyl phosphate ions. More preferably, at least one selected from the group consisting of diethylphosphinate ions and bis(2,4,4-trimethylpentyl)phosphinate ions, and still more preferably bis(2,4,4-trimethylpentyl)phosphinate ions.

Particularly preferable examples of the anion components include, for example, anions shown in Table 2 below.

In addition, examples of preferable combinations of cations and anions as the component (e) include combinations shown in Table 2 below.

### Radical Polymerization Initiator;

Examples of radical polymerization initiators include compounds that generate an active radical species thermally (thermal polymerization initiator) and compounds that generate an active radical species upon radiation (light) emission (radiation (light)polymerization initiator).

The radiation (light)polymerization initiator is not particularly limited as long as it decomposes upon light emission, generates radicals, and initiates polymerization, and examples thereof include the following.

Examples thereof include acetophenone, acetophenone benzyl ketal, 1-hydroxycyclohexyl phenyl ketone, 2,2-dimethoxy-1,2-diphenylethane-1-one, xanthone, fluorenone, benzaldehyde, fluorene, anthraquinone, triphenylamine, carbazole, 3-methylacetophenone, 4-chlorobenzophenone, 4,4′-dimethoxy benzophenone, 4,4′-diaminobenzophenone, benzoin propylether, benzoin ethylether, benzyldimethyl ketal, 1-(4-isopropylphenyl)-2-hydroxy-2-methylpropane-1-one, 2-hydroxy-2-methyl-1-phenylpropane-1-one, thioxanthone, diethylthioxanthone, 2-isopropylthioxanthone, 2-chlorothioxanthone, 2-methyl-1-[4-(methylthio)phenyl]-2-morpholino-propane-1-one, 2-benzyl-2-dimethylamino-1-(4-morpholinophenyl)-butanone-1,4-(2-hydroxyethoxy)phenyl-(2-hydroxy-2-propyl)ketone, 2,4,6-trimethylbenzoyldiphenylphosphine oxide, bis-(2,6-dimethoxybenzoyl)-2,4,4-trimethylpentylphosphine oxide, and oligo(2-hydroxy-2-methyl-1-(4-(1-methylvinyl)phenyl)propanone).

The amount of the radical polymerization initiator added with respect to 100 parts by mass of the component (c) is preferably 0.01 to 10 parts by mass, and more preferably 0.1 to 5 parts by mass. When the addition amount is 0.01 parts by mass or more, sufficient hardness of the cured product is obtained and when the addition amount is 10 parts by mass or less, the interior (lower layer) is sufficiently cured when formed into the cured product.

### Others

Other components can be added to the curable composition as necessary as long as the effects of the present disclosure are not impaired. For example, a polymerization inhibitor, a polymerization initiation assistant, a leveling agent, a wettability improving agent, a surfactant, a plasticizer, a UV absorbing agent, an antioxidant, an antistatic agent, an inorganic filler, a pigment and the like can be added.

### Method of Producing Curable Composition

The method of producing a curable composition is not particularly limited, and it is preferable to produce the curable composition as follows because it contains the component (a) and the component (b), which are particulate substances, and the component (c), which often has a high viscosity. A slurry in which the component (a) is dispersed in a solvent, a slurry in which the component (b) is dispersed in a solvent, and a solution in which the component (c) is dissolved in a solvent are prepared in advance. Then, these slurries, the component (d), the component (e), a polymerization initiator, and other components are put into a container including a stirrer in the following formulation, and stirred, for example, at room temperature for 30 minutes, and thereby a curable composition can be obtained. The concentration of the slurry or solution may be set to be within a range in which stirring becomes easy. The total amount of the solvents based on a total amount of 100 parts by mass of the component (a), the component (b), and the component (c) is, for example, 200 to 2,000 parts by mass, and preferably 500 to 1,200 parts by mass.

### Curing Method

The curable composition is preferably cured to obtain the surface layer. The curable composition can be cured by heat or radiation (light, electron beams, etc.). The curing method is not particularly limited as long as it is active radiation that can impart energy capable of generating a polymerization initiation species, and it broadly includes α rays, γ rays, X rays, ultraviolet rays (UV), visible light, electron beams and the like. Among these, in consideration of curing sensitivity and ease of availability of the apparatus, ultraviolet rays and electron beams are preferable, and ultraviolet rays are particularly preferable.

### Electrophotographic Member

An electrophotographic member will be described.

The electrophotographic member is composed of a plurality of layers, and a surface layer can be formed using the above curable composition. The electrophotographic member may be, for example, in the form of a roller or a belt, and is preferably in the form of a belt. An embodiment of an electrophotographic belt composed of two layers, a base layer and a surface layer, will be described below, but other layers such as an inner surface layer may be provided.

### Component (f)

### Resin;

The base layer can be a molded product of a base-layer-forming resin composition containing the component (e) and a resin. Preferably, the resin used to form the base layer can contain the component (e) and the component (e) can transfer to the curable composition. The resin used to form the base layer is not particularly limited, and various resins are used.

As specific examples, resins such as polyimide (PI), polyamide-imide (PAI), polypropylene (PP), polyethylene (PE), polyamide (PA), polylactic acid (PLLA), polyethylene terephthalate (PET), polyethylene naphthalate (PEN), polyphenylene sulfide (PPS), polyetheretherketone (PEEK), polycarbonate (PC), and fluorine resins (PVdF, etc.) and blend resins thereof are also preferably used. Particularly, the resin is preferably at least one selected from the group consisting of polyethylene terephthalate (PET) and polyethylene naphthalate (PEN).

The resin composition may contain other components as necessary. Examples of other components include ionic conducting agents (for example, a polymeric ionic conductive agent and a surfactant), conductive polymers, antioxidants (for example, hindered phenol-based, phosphorus, and sulfur-based antioxidants), UV absorbing agents, organic pigments, inorganic pigments, pH adjusting agents, crosslinking agents, compatibilizers, release agents (for example, silicone-based, and fluorine-based release agents), crosslinking agents, coupling agents, lubricants, insulating fillers (for example, zinc oxide, barium sulfate, calcium sulfate, barium titanate, potassium titanate, strontium titanate, titanium oxide, magnesium oxide, magnesium hydroxide, aluminum hydroxide, talc, mica, clay, kaolin, hydrotalcite, silica, alumina, ferrite, calcium carbonate, barium carbonate, nickel carbonate, glass powder, quartz powder, glass fibers, alumina fibers, potassium titanate fibers, and thermosetting resin fine particles), conductive fillers (for example, carbon black, carbon fibers, conductive titanium oxide, conductive tin oxide, and conductive mica), and ionic liquids. These may be used alone or two or more thereof may be used in combination.

The base layer may contain base layer particles. It is preferable that protruded portions derived from the base layer particle be present on the surface of the surface layer.

The height of the protruded portions derived from the base layer particles is, for example, 0.1 to 5.0 μm, preferably 0.3 to 2.0 μm, and more preferably 0.4 to 1.5 μm.

The width of the protruded portions derived from the base layer particles is, for example, 0.5 to 5.0 μm, preferably 1.0 to 4.0 μm, and more preferably 1.0 to 3.0 μm.

Regarding the protruded portions derived from the base layer particles, the average number of the protruded portions in an area of 256 μm×192 μm is, for example, 1 to 22, preferably 1 to 20, and more preferably 4 to 20. The average number of the protruded portions may be 1 to 15.

The presence of such protruded portions makes it easier to assist in restricting adhesion to other members.

The number-average particle diameter of the base layer particles is preferably 1.5 to 3.5 μm and more preferably 1.8 to 3.2 μm. When particles having the above average particle diameter are added to the resin composition, and protruded portions derived from the particles added to the resin composition are formed on the outer surface of the surface layer opposite to the surface that faces the base layer, it is possible to assist in restricting adhesion to other members.

The protruded portions derived from the base layer particles may be such that at least some of the base layer particles are exposed on the surface of the surface layer, or the surface of the base layer particles may be coated with the matrix resin in the surface layer.

### Method of Producing Base Layer

The method of producing a base layer is not particularly limited, and molding methods suitable for various resins may be used. The base layer can be obtained by heating and molding the resin composition containing the component (e) and the component (f) as necessary. Examples of molding methods include extrusion molding, inflation molding, blow molding, and centrifugal molding. The component (e) and the component (f) are melt-kneaded to obtain a resin composition, and the resin composition can be then extrusion-molded to obtain a cylindrical film-shaped base layer. Known apparatuses such as a twin-screw kneading extruder can be used for melt-kneading.

In examples and comparative examples to be described below, the base layer is obtained by extrusion molding.

### Method of Forming Surface Layer

The surface layer has protruded portions derived from heteroaggregates on the outer surface opposite to the surface that faces the base layer. The method of producing a surface layer is not particularly limited, and as described above, the method preferably has a step of applying a curable composition to a base layer and curing the composition to obtain a surface layer.

More preferably, the method of producing an electrophotographic belt includes a step of preparing a base layer containing the following component (e); a step of preparing a curable composition containing the following component (a) to component (d); a step of forming a coating of the curable composition on one surface of the base layer and drying the coating; and a step of curing the dried coating.
(a) first particles that are chain-like inorganic oxide particles;
(b) second particles that are different from the first particles, and have a number-average particle diameter of primary particles of 5 to 40 nm, and contain a conductive metal oxide;
(c) (meth)acrylic monomers;
(d) at least one solvent selected from the group consisting of 2-butanone and 4-methyl-2-pentanone;
(e) a salt containing at least one cation selected from the group consisting of the cations represented by Formulae (C1) to (C4) and at least one anion selected from the group consisting of the anions represented by Formulae (A1) to (A4).

By the production method, as described above, a small amount of the cations transfers from the base layer into the coating of the surface-layer-forming composition, and an increase in the cation concentration during curing of the coating causes heteroaggregates of the first particles and the second particles to be formed in the coating and protruded portions to be formed.

The application method is not particularly limited, and known methods may be used. In examples and comparative examples to be described below, dip coating is used.

For example, the base layer is fitted onto the outer circumference of a cylindrical mold, the ends are sealed, the mold is then immersed in a container filled with a curable composition, the mold is lifted so that the relative speed between the liquid surface of the curable composition and the base layer is constant, and thus a coating of the curable composition is formed on the surface of the base layer. According to the desired film thickness, the lifting speed (the relative speed between the liquid surface of the curable composition and the base layer), the solvent ratio of the curable composition and the like may be adjusted.

For example, the lifting speed can be 10 to 50 mm/sec.

After the coating is formed, the coating is dried and cured. In the step of drying the coating, the drying temperature, the humidity, and the drying time may be appropriately adjusted depending on the type of the solvent, the solvent ratio, the film thickness and the like. The drying temperature is preferably, for example, 20 to 30° C. The relative humidity during dry is preferably 40 to 70%. In addition, the drying time is preferably 30 to 300 seconds. In addition, it is preferable to perform exhausting during drying. Exhaust conditions are not particularly limited as long as they are not sufficient to remove the solvent, and an exhaust air volume is preferably 10 to 50 m³/min, and more preferably 30 to 50 m³/min. The above drying makes it easier for the cation component to transfer.

Then, the dried coating is cured to obtain a surface layer. For example, it can be cured by UV emission. The cumulative light amount can be set appropriately depending on the material to be used. For example, 300 to 2,000 mJ/cm² can be set.

The sum of the content of the first particles and the content of the second particles in the surface layer based on the mass of the surface layer is preferably 4.0 to 37.0 mass %, more preferably 6.0 to 37.0 mass %, and still more preferably 6.0 to 30.0 mass %.

In addition, the content of first particles in the surface layer based on the mass of the surface layer is preferably 0.2 to 27.0 mass %, and more preferably 0.4 to 12.0 mass %.

In addition, the content of second particles in the surface layer based on the mass of the surface layer is preferably 3.8 to 30.0 mass %, more preferably 5.0 to 25.0 mass %, and still more preferably 6.0 to 22.0 mass %.

In addition, when the ionic conducting agent in the base layer causes heteroaggregates of the first particles and the second particles to be formed in the coating of the surface-layer-forming composition formed on the base layer, the sum of the contents of cations and anions in the base layer based on the mass of the base layer is preferably 0.4 to 3.5 mass %, more preferably 0.7 to 3.0 mass %, and still more preferably 0.8 to 3.0 mass %. When the content of the ionic conducting agent in the base layer is set to be within the above range, it is possible to more efficiently form heteroaggregates of the first particles and the second particles in the surface layer. As a result, the arithmetic mean height (Sa) of the outer surface of the surface layer can be more easily set to 0.1 to 0.7 μm.

The thickness of the surface layer is not particularly limited, and is 0.05 μm to 20 μm, particularly 0.1 μm to 5 μm, and more preferably 1 μm to 3 μm. Particularly, when particles are added to the base layer to form protruded portions derived from the base layer particles on the surface of the surface layer, if the film thickness of the surface layer is thick, since the protruded portions are less likely to be formed, it is preferable to adjust the film thickness of the surface layer according to the particle diameter of the particles to be added. For example, when particles having a particle diameter of 1.5 to 3.5 μ are added to the base layer, the thickness of the surface layer is preferably 1 μm to 3 μm.

### Electrophotographic Image Forming Apparatus

An electrophotographic image forming apparatus (hereinafter referred to as an “electrophotographic apparatus”) will be described. FIG. 2 is a cross-sectional view of a full-color electrophotographic apparatus. The electrophotographic apparatus preferably includes an electrophotographic member as an intermediate transfer belt. The electrophotographic member is preferably an intermediate transfer belt. In FIG. 2, the electrophotographic apparatus includes a cylindrical electrophotographic seamless belt as an intermediate transfer belt 5.

An electrophotographic photosensitive member 1 is a drum-shaped electrophotographic photosensitive member (hereinafter referred to as a “photosensitive drum”) that is repeatedly used as a first image bearing member, and is driven to rotate at a predetermined peripheral velocity (process speed) in the arrow direction.

During the rotation process, the photosensitive drum 1 is uniformly charged at a predetermined polarity and potential by a primary charging device 2. 32 indicates a power source. Next, the photosensitive drum is subjected to image exposure 3 by an exposure means, and thus an electrostatic latent image corresponding to a first color component image (for example, a yellow color component image) with a desired color image is formed. Here, examples of the exposure means include a color separation and imaging exposure optical system for a color original image and a scanning exposure system using a laser scanner that outputs a laser beam modulated in response to time- series electric digital pixel signals of image information.

Next, the electrostatic latent image on the photosensitive drum is developed with yellow toner Y which is a first color, by a first developing device (a yellow color developing device 41). In this case, each of second to fourth developing devices (a magenta color developing device 42, a cyan color developing device 43, and a black color developing device 44), is turned off, and does not act on the photosensitive drum 1, and the yellow toner image with the first color is not affected by the second to fourth developing devices. The electrophotographic belt 5 is driven to rotate at the same peripheral velocity as the photosensitive drum 1 in the arrow direction.

When the yellow toner image on the photosensitive drum 1 passes through the nip part between the photosensitive drum 1 and the intermediate transfer belt 5, it is transferred to the outer peripheral surface of the intermediate transfer belt 5 by an electric field formed by a primary transfer bias applied from the power source 30 to the electrophotographic belt 5 via a primary transfer opposing roller 6 (primary transfer). After the yellow toner image with the first color is completely transferred to the electrophotographic belt 5, the surface of the photosensitive drum 1 is cleaned by a cleaning device 13.

Hereinafter, similarly, a magenta toner image with a second color, a cyan toner image with a third color, and a black toner image with a fourth color are transferred in sequence onto the electrophotographic (intermediate transfer) belt 5 in an overlapping manner, and a composite color toner image corresponding to a desired color image is formed. A secondary transfer roller 7 is parallel to and supported by a driver roller 8 and disposed at a part below the electrophotographic belt 5 in a separable manner.

During the step of primary transfer of the first to third color toner images from the photosensitive drum 1 to the electrophotographic belt 5, the secondary transfer roller 7 can also be separated from the electrophotographic belt 5. The composite color toner image transferred onto the electrophotographic belt 5 is transferred to a transfer material P, which is a second image bearing member, as follows.

First, the secondary transfer roller 7 is brought into contact with the electrophotographic belt 5, and the transfer material P is fed from a paper feed roller 11 through a transfer material guide 10 to the contact nip between the electrophotographic belt 5 and the secondary transfer roller 7 at a predetermined timing. Then, a secondary transfer bias is applied from a power source 31 to the secondary transfer roller 7. This secondary transfer bias causes a composite color toner image to be transferred from the electrophotographic (intermediate transfer) belt 5 to a transfer material P, which is a second image bearing member (secondary transfer).

The transfer material P to which the toner image is transferred is introduced into a fixing unit 15 and heated and fixed. After the image is completely transferred to the transfer material P, a cleaning roller 9 of the cleaning device is brought into contact with the electrophotographic belt 5, and a bias of the opposite polarity to that of the photosensitive drum 1 is applied. Thereby, a charge of the opposite polarity to that of the photosensitive drum 1 is applied to the toner (transfer residual toner) that is not transferred to the transfer material P but remains on the electrophotographic belt 5. 33 indicates a bias power source. The transfer residual toner is electrostatically transferred to the photosensitive drum 1 at the nip part with the photosensitive drum 1 and in the vicinity thereof, and thus the electrophotographic belt 5 is cleaned.

### Evaluation Method

Methods of measuring and evaluating physical properties according to the present disclosure will be described.

### Roughness Arithmetic Mean Height Sa

The arithmetic means height Sa of the surface layer is measured using a scanning white-light interference microscope (product name: VertScan, commercially available from Ryoka Systems Inc.). Observation is performed at a magnification of 50×, the obtained image is subjected to fourth-order surface correction, and an Sa is then determined from the corrected image. Four images are obtained, an Sa is measured and an arithmetic average value is used.

### Adhesion to Other Members

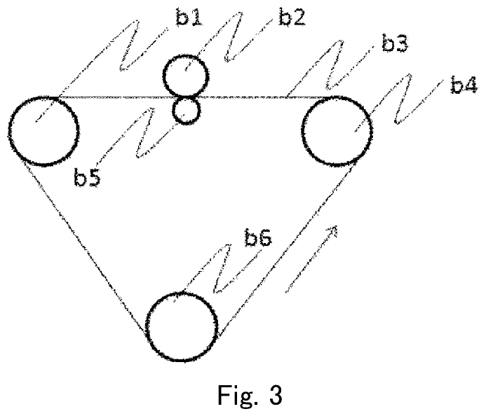

The adhesion to the photosensitive drum of the full-color electrophotographic apparatus (product name: LBP-5200, commercially available from CANON KABUSHIKI KAISHA) is measured using a jig as shown in FIG. 3. The electrophotographic belt b3 is tensioned by a driver roller b1 including a motor and a torque meter, a driven roller b4, and a tension roller b6 that applies tension to an electrophotographic belt b3 as an electrophotographic member. In a photosensitive drum b2 and a backup roller b5, the photosensitive drum and the transfer roller of LBP-5200 and are used, respectively.

The electrophotographic belt that is not in contact with the photosensitive drum is rotated at 180 mm/sec, and the torque value in this case is measured. This value is called “Tq1”. Next, while rotating the electrophotographic belt at 180 mm/sec, the maximum value of the torque when the photosensitive drum is brought into contact with the electrophotographic belt at 700 gf is measured. This value is called “Tq2”. Here, the difference between “Tq2” and “Tq1” is used as an index for evaluating the adhesion between the electrophotographic belt and the photosensitive drum. Thus, when the difference is less than 0.10 Nm, an evaluation rank of “A” is assigned, and when the difference is 0.10 Nm or more, an evaluation rank of “B” is assigned.

The adhesion is evaluated after durable use. The adhesion evaluation after durable use is performed by measurement after 50,000 electrophotographic images are formed using the full-color electrophotographic apparatus.

In addition, when the electrophotographic belt and the photosensitive drum are brought into contact with each other, the photosensitive drum is fixed and not rotated, and the contact surface of the photosensitive drum is always in new condition.

### Adhesion to Other Members (High Contact Pressure)

In order to evaluate the adhesion to other members under stricter conditions, the contact pressure with the photosensitive drum is set to 1,000 gf, the other conditions are the same as those for the procedure for the adhesion to other members, and the adhesion to other members is evaluated in a high contact pressure state.

### Presence of Heteroaggregates

Samples cut out from the surface layer of the electrophotographic member using a microtome or the like are observed using a TEM (Talos200, commercially available from FEI), and cross-sectional images of the surface layer in the thickness direction are captured.

In addition, element analysis is performed using a transmission electron microscope and an EDX method (energy dispersive X-ray spectroscopy). Specifically, analysis is performed using Talos200 (commercially available from FEI) at an acceleration voltage of 200 kV. The particles in the cross-sectional TEM image are distinguished into the first particles and the second particles. When there are aggregates containing both the first particles and the second particles, it is determined that there are heteroaggregates.

### Presence of Protruded Portions Derived from Heteroaggregates

Samples cut out from the surface layer of the electrophotographic member using a microtome or the like are observed using a Transmission Electronmicroscope (TEM), and cross-sectional images of the surface layer in the thickness direction are captured. The procedure is the same as the above procedure for determining the presence of heteroaggregates. In this case, the image is captured such that it includes the outermost surface of the surface layer.

In addition, element analysis is performed using an EDX method (energy dispersive X-ray spectroscopy) in the same manner as in the procedure for determining the presence of heteroaggregates, and the particles in the cross-sectional TEM image are distinguished into the first particles and the second particles.

When the surface layer contains aggregates containing the first particles and the second particles, that is, heteroaggregates, and protruded portions reflecting the shape of heteroaggregates are formed on the outermost surface of the surface layer, it is determined that there are the protruded portions derived from the heteroaggregates. Here, the protruded portions are portions where heteroaggregates themselves are exposed on the outer surface of the surface layer and portions where the matrix resin of the surface layer that covers the heteroaggregates is raised, and the other portions are determined to be non-protruded portions.

### Long Diameter and Short Diameter of First Particle

The long diameter and the short diameter of first particles are determined by the following method.

Samples cut out from the surface layer of the electrophotographic member using a microtome or the like are subjected to acid decomposition and then observed under an SEM (ULTRA 55, commercially available from ZEISS).

### Acid Decomposition Conditions

Acid: nitric acid (68%) 7.5 ml+hydrochloric acid (30%) 0.5 ml
Amount of sample: 0.2 g
Acid decomposition device: ETHOS PRO (commercially available from Milestone General K. K.)
Heating: Heated to 70° C. in 2 minutes→cooled to 50° C. in 1 minute→heated to 230° C. in 20 minutes→held at 230° C. for 20 minutes

The short diameter and the long diameter can be measured by performing image processing on the observed SEM images. As an image processing method, image processing software ImageJ (NIH, ver1.51) is used to perform the following procedure. In the image area, an Auto button which automatically sets the threshold level is selected, and binarization is performed to extract the shape of the chain-like particles.

Then, the binary image is duplicated, one image can be subjected to particle analysis (Analyze Particles) to obtain the Feret diameter and area of each chain-like particle. The other binary image can be subjected to Skeletonization to obtain the skeleton length of each chain-like particle.

The short diameter is calculated by dividing the total chain-like particle area by the total skeleton length. The long diameter corresponds to each Feret diameter. 100 particles are measured, and the number average value is calculated.

### Number-Average Particle Diameter of Primary Particles of Second Particles

The number-average particle diameter of primary particles of second particles is determined by the following method.

Samples cut out from the surface layer of the electrophotographic member using a microtome or the like and cross-sectional images of the surface layer in the thickness direction are captured using a TEM (commercially available from FEI Talos200). In addition, element analysis is performed using an EDX method (energy dispersive X-ray spectroscopy), and the first particles and the second particles that constitute heteroaggregates in the TEM image are distinguished. The procedure is the same as the above procedure for determining the presence of heteroaggregates.

Next, in the above image, the value obtained by dividing the sum of the maximum length and the minimum length of the primary particles in the projected image of the second particles constituting the heteroaggregates by 2 is used as the particle diameter of the second particles. This operation is performed for 100 second particles constituting the heteroaggregates, and the arithmetic average value of the obtained primary particle diameters is used as the number-average particle diameter of primary particles of the second particles.

### Content of Particles

The contents of first particles and second particles in the surface layer can be determined by the following method.

The surface layer is peeled off from the electrophotographic member using a razor or the like and measured in air at 400° C. using a Thermogravimetric Analysis (TGA) device, and a profile of measurement time-weight reduction rate is obtained. In the profile, the initial mass is obtained. In addition, in the profile, the mass when the slope becomes constant is defined as the total mass of the particles. The value of [the total mass of the particles]/[the initial mass]×100 is the sum (mass %) of the contents of the first particles and the second particles in the surface layer.

In addition, separately, the surface layer whose mass is measured is heated to 400 degrees, and the mass of the residue is measured. In addition, the residue is separated into the first particles and the second particles by centrifugation or the like and the mass of respective particles after drying is measured. The value of [the mass of the first particles]/[the mass of the surface layer]×100 is the content (mass %) of the first particles in the surface layer. In addition, the value of [the mass of the second particles]/[the mass of the surface layer]×100 is the content (mass %) of the second particles in the surface layer.

### Sum of Contents of Cations and Anions in Base Layer

The contents of cations and anions in the base layer can be determined by the following method.

The base layer is peeled off from the electrophotographic member using a razor or the like, 200 mg of a sample is cut out from the base layer, the sample is immersed in 1 mL of methanol, and then 40 kHz ultrasonic waves are applied for 10 minutes to obtain an extraction liquid containing anions and cations. When the mass of the dried substance obtained by removing methanol from the extraction liquid is measured, a total amount of cations and anions contained in 200 mg of the base layer can be determined. The value of [the total amount (mg) of cations and anions]/[200 mg]×100 is the sum (mass %) of the contents of cations and anions in the base layer.

### Presence of Protruded Portions Derived from Base Layer Particles

The shape of the surface is observed from the side of the surface layer of the electrophotographic member using a scanning electron microscope with a focused ion beam function, and protruded portions are identified. Specifically, the secondary electron layer of the surface is obtained at an acceleration voltage of 3 kV using AmberX (commercially available from TESCAN), and protruded portions are identified. For the observed protruded portions, a cross section is created using the focused ion beam function so that the cross section including the apices of the protruded portions is created. When particles are observed in the cross section, and some or all of the particles are embedded in the base layer, it is determined that the protruded portions are derived from the base layer particles.

### Height of Protruded Portions Derived from Base Layer Particles

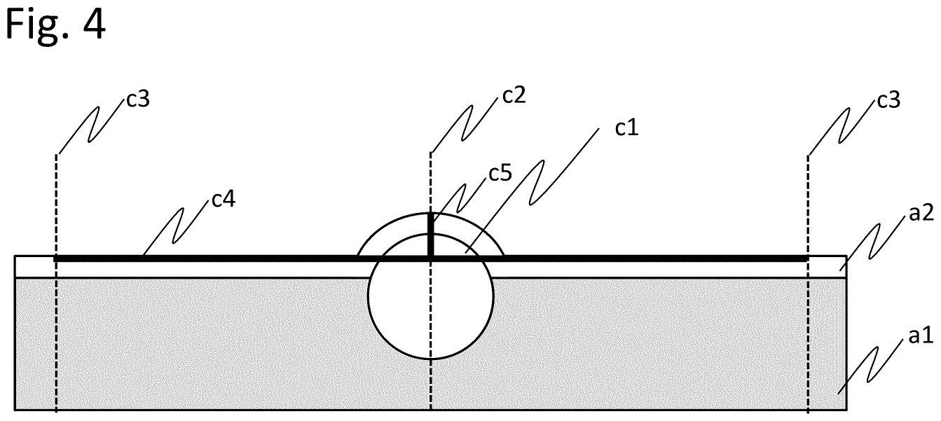

In the same manner as in the above procedure for determining the presence of the protruded portions derived from the base layer particles, a cross section of the protruded portion is created using the focused ion beam function, and a cross-sectional image including the apices of the protruded portions is obtained. As shown in FIG. 4, a straight line connecting positions c3 that are separated by three times the particle diameter of the base layer particle from a center c2 of the base layer particle c1 observed in the cross section is defined as a baseline c4. When the distance from the baseline c4 to the apex of the protruded portion is measured, the height of the protruded portion is determined. The average value obtained when 30 protruded portions are evaluated is defined as a height c5 of the protruded portions derived from the base layer particles.

### Width of Protruded Portions Derived from Base Layer Particles

The shape of the surface is observed from the side of the surface layer of the electrophotographic member using a scanning electron microscope with a focused ion beam function, and a secondary electron image of the surface is obtained. The width of the protruded portion can be measured by performing image processing on the obtained secondary electron image. As an image processing method, image processing software ImageJ (NIH, ver1.51) is used, binarization is performed to extract the shape of the protruded portion, the diameter of the protruded portion is obtained using the particle diameter analysis function, and this value is used as the width of the protruded portion.

The average value obtained when 30 protruded portions are evaluated is defined as the width of the protruded portions derived from the base layer particles. Here, it is confirmed that the protruded portion extracted by image processing is the protruded portion derived from the base layer particle by creating the cross section.

### Number of Protruded Portions Derived from Base Layer Particles

In the same manner as in the above procedure for measuring the width of the protruded portions derived from the base layer particles, the shape of the surface is observed using a scanning electron microscope, the protruded portions are extracted by image processing, and the number of protruded portions is counted. The average value obtained when 30 secondary electron images in a field of view of 256 μm×192 μm are evaluated is defined as the number of protruded portions derived from the base layer particles. Here, it is confirmed that the protruded portion extracted by image processing is the protruded portion derived from the base layer particle by creating the cross section.

### Particle Diameter of Base Layer Particles

The particle diameter of particles in the base layer can be determined by the following method.

Samples cut out from the base layer of the electrophotographic member using a microtome or the like are decomposed by heating in air at 380° for 4 hours to decompose the resin composition, and the particles are extracted and observed under an SEM. The particle diameter can be measured by performing image processing on the secondary electron image obtained using the SEM. As an image processing method, image processing software ImageJ (NIH, ver1.51) is used, binarization is performed to extract the shape of the particle, and the particle diameter can be determined using the particle diameter analysis function. The average value obtained when 100 particles are evaluated is defined as the number-average particle diameter of the base layer particles.

### Content of Base Layer Particles

The content of particles in the base layer can be determined by the following method.

The base layer peeled off from the electrophotographic member using a razor or the like and measured in air at 380° C. using a Thermogravimetric Analysis (TGA) device, and a profile of measurement time-weight reduction rate is obtained. In the profile, the initial mass is obtained. In addition, in the profile, the mass when the slope becomes constant is defined as the total mass of the particles. The value of [the total mass of the particles]/[the initial mass]×100 is the content (mass %) of the particles in the base layer.

### EXAMPLES

The present disclosure will be described below in detail with reference to examples and comparative examples, but the present disclosure is not limited thereto.

### Base Layer

Table 1 and Table 1-2 show the mixing ratios of the materials constituting the base layer. The structural formulae and names of the component (e) in the base layer are shown in Table 2.

First, respective materials shown in Table 1 and Table 1-2 were melted and mixed in addition amounts shown in Table 1 and Table 1-2 using a twin-screw kneading extruder (product name: PCM43, commercially available from Ikegai) under the following conditions to produce thermoplastic resin compositions.
Extrusion amount: 6 kg/h
Screw rotational speed: 225 rpm
Barrel control temperature: 270° C.

The obtained thermoplastic resin composition was melted and extruded using a single-screw extrusion molding machine including a spiral cylinder die (an inner diameter of 195 mm and a slit width of 1.1 mm) at the tip (commercially available from PLABOR Research Laboratory of Plastics Technology Co., Ltd.) under the following conditions, and a cylindrical film having the following size was produced. The cylindrical film thus obtained was used as a base layer.
Extrusion amount: 6 kg/h
Die temperature: 290° C.
Size: an outer diameter of 201 mm and a thickness of 70 μm

### Surface Layer

In addition, Table 3 shows the mixing ratio of the materials constituting the curable composition for forming the surface layer. In Table 3, when the materials were slurries, the solid components were adjusted to conform to the mixing ratio shown in Table 3.

Here, a curable composition was prepared as follows.

A slurry in which the component (a) was dispersed in a solvent, a slurry in which the component (b) was dispersed in a solvent, and a solution in which the component (c) was dissolved in a solvent were prepared in advance, these preparations and a component (d), a component (e), a polymerization initiator, and other components were mixed as shown in Table 3, put into a container including a stirrer, and stirred at room temperature for 30 minutes to obtain a curable composition.

The base layer obtained by extrusion molding was fitted onto the outer circumference of a cylindrical mold, the ends were sealed, the mold was then immersed in a container filled with a curable composition, the mold was lifted so that the relative speed between the liquid surface of the curable composition and the base layer was constant, and thus a coating of the surface-layer-forming curable composition was formed on the surface of the base layer.

In examples and comparative examples, the lifting speed was set to 10 to 50 mm/sec, and the film thickness of the coating of the curable composition was adjusted to 2 μm. The curable composition was mixed at the formulation shown in Table 3. After the coating of the curable composition was formed, the coating was dried for 1 minute under an environment of a temperature of 23° C. and a relative humidity of 55% and under an exhaust air at an exhaust air volume of 40 m³/min. Next, ultraviolet rays were emitted to the dried coating using an UV emission device (product name: UE06/81-3, commercially available from Eye Graphics Co., Ltd.) until the cumulative light amount reached 600 mJ/cm², and the coating was cured to form a surface layer. The thickness of the obtained surface layer was 2 μm as a result of observing the cross section under an electron microscope.

Table 4 and Table 4-1 show the combinations of base layers and curable compositions used in the examples and comparative examples. In addition, Table 5 and Table 5-2 show the evaluation results.

TABLE 1

| | Resin composition (f) | | Component (e) | |
|---|---|---|---|---|
| | | Addition amount | | Addition amount |
| | No. | (parts by mass) | No. | (parts by mass) |
| Base | f-1 | 99.6 | e-1 | 0.4 |
| layer 1 | | | | |
| Base | f-1 | 99.2 | e-1 | 0.8 |
| layer 2 | | | | |
| Base | f-1 | 97.0 | e-1 | 3.0 |
| layer 3 | | | | |
| Base | f-1 | 96.5 | e-2 | 3.5 |
| layer 4 | | | | |
| Base | f-2 | 99.2 | e-1 | 0.8 |
| layer 5 | | | | |
| Base | f-1 | 99.2 | e-3 | 0.8 |
| layer 6 | | | | |
| Base | f-1 | 99.2 | e-4 | 0.8 |
| layer 7 | | | | |
| Base | f-1 | 99.2 | e-5 | 0.8 |
| layer 8 | | | | |
| Base | f-1 | 99.2 | e-6 | 0.8 |
| layer 9 | | | | |

The resins (f) used are as follows.
f-1 “TN-8065S” (product name, commercially available from Teijin Ltd.); polyethylene naphthalate
f-2 “TRN-8550FF” (product name, commercially available from Teijin Ltd.); polyethylene terephthalate

TABLE 1-2

| | Resin composition (f) | | Component (e) | | Particles (g) | |
|---|---|---|---|---|---|---|
| | | Addition amount | | Addition amount | | Addition amount |
| | No. | (parts by mass) | No. | (parts by mass) | Type | (parts by mass) |
| Base Layer | f-1 | 98.7 | e-1 | 0.8 | g-1 | 0.5 |
| 101 | | | | | | |
| Base Layer | f-1 | 98.4 | e-1 | 0.8 | g-1 | 0.8 |
| 102 | | | | | | |
| Base Layer | f-1 | 97.2 | e-1 | 0.8 | g-1 | 2.0 |
| 103 | | | | | | |
| Base Layer | f-1 | 98.7 | e-1 | 0.8 | g-2 | 0.5 |
| 104 | | | | | | |
| Base Layer | f-1 | 98.4 | e-1 | 0.8 | g-2 | 0.8 |
| 105 | | | | | | |
| Base Layer | f-1 | 97.2 | e-1 | 0.8 | g-2 | 2.0 |
| 106 | | | | | | |

The particles (g) used are as follows.
g-1 “Tospearl 120” (product name, commercially available from Momentive Performance Materials Japan LLC)
g-2 “Tospearl 130” (product name, commercially available from Momentive Performance Materials Japan LLC)

TABLE 2

| No. | Structural formula | | Name |
|---|---|---|---|
| e-1 | 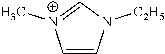 | 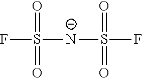 | 1-Ethyl-3-methylimidazolium bis(fluorosulfonyl)imide (commercially available from Kanto Chemical Co., Inc.) |
| e-2 | 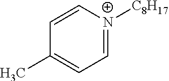 | 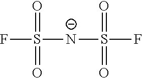 | ELEXCEL AS-804 (commercially available from DKS Co., Ltd.) |
| e-3 | 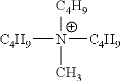 | 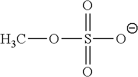 | Tributylmethylammonium methyl sulfate (commercially available from Santa Cruz Biotechnology) |
| e-4 | 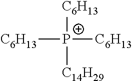 | 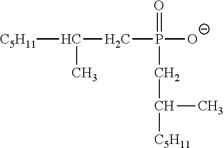 | Trihexyltetradecylphosphonium bis(2,4,4-trimethylpentyl)sulfonate (commercially available from Sigma- Aldrich) |
| e-5 | 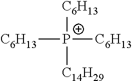 | 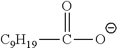 | Trihexyltetradecylphosphonium decanoate (commercially available from Sigma- Aldrich) |

| | | |
|---|---|---|
| e-6 | 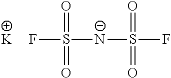 | Potassium bis(fluorosulfonyl)imide (commercially available from Daito Kasei Kogyo Co., Ltd.) |

TABLE 3

| | | | | | | | | | | | Polymeri- | |
|---|---|---|---|---|---|---|---|---|---|---|---|---|
| | | | | | | | | | Component (d) | | zation | |
| | | | | | | | | | 4-methyl- | 2- | initiator | Silica particles |
| | Component (a) | | Component (b) | | | | Component (c) | | 2-pentanone | butanone | *2 | with primary |
| | | Addition | | Addition | | Addition | | Addition | Addition | Addition | Addition | particle diameter |
| Curable | | amount | | amount | | amount | | amount | amount | amount | amount | of 20 nm *1 |
| composition | | (parts by | | (parts by | | (parts by | | (parts by | (parts by | (parts by | (parts by | Addition amount |
| No. | No. | mass) | No. | mass) | No. | mass) | No. | mass) | mass) | mass) | mass) | (parts by mass) |
| 1 | a-1 | 1.0 | b-1 | 14.0 | — | — | c-1 | 100 | 520 | 70 | 7.6 | — |
| 2 | a-1 | 1.0 | b-2 | 14.0 | — | — | c-1 | 100 | 520 | 70 | 7.6 | — |
| 3 | a-1 | 1.0 | b-3 | 14.0 | — | — | c-1 | 100 | 520 | 70 | 7.6 | — |
| 4 | a-1 | 1.0 | b-4 | 14.0 | b-4 | 14.0 | c-1 | 100 | 520 | 70 | 7.6 | — |
| 5 | a-1 | 1.0 | b-1 | 14.0 | b-2 | 14.0 | c-1 | 100 | 520 | 70 | 7.6 | — |
| 6 | a-1 | 0.5 | b-1 | 14.0 | — | — | c-1 | 100 | 520 | 70 | 7.6 | — |
| 7 | a-1 | 4.0 | b-1 | 14.0 | — | — | c-1 | 100 | 520 | 70 | 7.6 | — |
| 8 | a-1 | 16.0 | b-1 | 14.0 | — | — | c-1 | 100 | 520 | 70 | 7.6 | — |
| 9 | a-1 | 1.0 | b-1 | 7.0 | — | — | c-1 | 100 | 520 | 70 | 7.6 | — |
| 10 | a-1 | 1.0 | b-1 | 30.0 | — | — | c-1 | 100 | 520 | 70 | 7.6 | — |
| 11 | a-2 | 1.0 | b-1 | 14.0 | — | — | c-1 | 100 | 520 | 70 | 7.6 | — |
| 12 | a-3 | 1.0 | b-2 | 14.0 | — | — | c-1 | 100 | 520 | 70 | 7.6 | — |
| 13 | a-1 | 16.0 | b-1 | 30.0 | — | — | c-1 | 100 | 520 | 70 | 7.6 | — |
| 14 | — | — | b-3 | 14.0 | — | — | c-1 | 100 | 520 | 70 | 7.6 | 1.0 |

The materials used are as follows.
a-1 “IPA-ST-UP” (product name, commercially available from Nissan Chemical Corporation); silica particle slurry (a solid content concentration of 15 mass %)
a-2 “PL-1” (product name, commercially available from Fuso Chemical Co., Ltd.); silica particle slurry (a solid content concentration of 12 mass %)

### Preparation of a-3

100 g of a silica sol (“Cataloid SI-550” (product name, a solid content concentration of 20 mass %), commercially available from JGC Catalysts and Chemicals Ltd.) was repeatedly passed through 0.4 L of a strongly acidic cation exchange resin SK1BH (commercially available from Mitsubishi Chemical Corporation) at a space velocity of 3.1 per hour until the pH reached 2.8. Next, this silica sol was passed through 0.4 L of a strongly basic ion exchange resin SANUPC (commercially available from Mitsubishi Chemical Corporation) at a space velocity of 3.1 per hour to adjust the pH to 4.1, and 5 g of a 5% sodium hydroxide aqueous solution was then added as an alkaline aqueous solution to adjust the pH to 8.5. The pH-adjusted silica sol was heated at 180° C. for 2 hours, and then concentrated to a silica concentration of 20 mass % using an evaporator to obtain a chain-like silica particle-dispersed sol.

### Preparation of b-1

12.0 g of antimony-containing tin oxide particles (product name: SN-100P, commercially available from Ishihara Sangyo Kaisha, Ltd.), 0.12 g of acetic acid (commercially available from Kishida Chemical Co., Ltd.) as an organic acid, 0.03 g of trioctyl amine (commercially available from Kishida Chemical Co., Ltd.) as an amine compound, and 48.0 g of isopropyl alcohol (commercially available from Kishida Chemical Co., Ltd.) as a solvent were weighed out and put into a 250 mL zirconia container. In addition, 108.3 g of zirconia beads with a diameter of 0.5 mm was added to the container.

Then, the mixture was stirred using a planetary ball mill (model: P-6, commercially available from Fritsch Japan Co., Ltd.) at 400 rpm for 3 hours. Then, the beads were removed through mesh filtration to obtain a dispersion liquid b-1 having a solid content concentration of ATO particles (that is, the content of ATO particles in the dispersion liquid) of 20 mass %.

### Preparation of b-2

100 g of antimony-containing tin oxide particles (product name: SN-100P, commercially available from Ishihara Sangyo Kaisha, Ltd.) was put into a Henschel mixer, and while rotating the mixer, 3.79 g of trimethoxymethylsilane (product name KBM-13, commercially available from Shin-Etsu Silicones) was added dropwise, and the mixture was stirred for 2 hours. The powder was then removed and heated and dried in a drying furnace at 100° C. for 1 hour to obtain ATO particles with a surface treatment rate of 30%.

12.50 g of the ATO particles with a surface treatment rate of 30%, 0.09 g of trioctyl amine (commercially available from Kishida Chemical Co., Ltd.) as an amine compound, 0.50 g of phosphate polyester (product name: BYK111, Commercially available from BYK-Chemie GmbH, molecular weight of about 800 to 1,500) as a phosphorus compound, and 18.13 g of 2-butanone (commercially available from Kishida Chemical Co., Ltd.) as a solvent were weighed out and put into a 250 mL zirconia container. In addition, 42.86 g of zirconia beads with a diameter of 0.5 mm was added to the container.

Then, the mixture was stirred using a planetary ball mill (model: P-6, commercially available from Fritsch Japan Co., Ltd.) at 400 rpm for 3 hours. Then, the beads were removed through mesh filtration to obtain a dispersion liquid b-2 having a solid content concentration of ATO particles (that is, the content of ATO particles in the dispersion liquid) of 40 mass %.
b-3 “CELL NAX CX-Z400K” (product name, commercially available from Nissan Chemical Corporation)
b-4 “CELL NAX CX-Z410K” (product name, commercially available from Nissan Chemical Corporation)
c-1 “ARONIX M-305” (product name, commercially available from Toagosei Co., Ltd.)

In the tables, *1 and *2 refer to the following.
*1 Snowtex MEK-ST″ (product name, commercially available from Nissan Chemical Corporation); silica particle slurry
*2 “Irgacure 907” (product name, commercially available from BASF Ltd.)

TABLE 4

| | | | | | | | | Total amount | |
|---|---|---|---|---|---|---|---|---|---|
| | | | | | Primary | Amount of | Amount of | of component | Amount of |
| | | | Long | Long | particle | component | component | (a) and | component |
| | | | diameter of | diameter/ | diameter of | (a) in | (b) in | component | (e) in |
| | Base | Curable | component | short | component | surface | surface | (b) in surface | surface |
| Example | layer | composition | (a) | diameter of | (b) | layer | layer | layer | layer |
| No. | No. | No. | [nm] | component (a) | [nm] | [mass %] | [mass %] | [mass %] | [mass %] |
| 1 | 1 | 1 | 66 | 6 | 20 | 0.8 | 11.4 | 12.2 | 0.4 |
| 2 | 2 | 1 | 66 | 6 | 20 | 0.8 | 11.4 | 12.2 | 0.8 |
| 3 | 3 | 1 | 66 | 6 | 20 | 0.8 | 11.4 | 12.2 | 3.0 |
| 4 | 4 | 1 | 66 | 6 | 20 | 0.8 | 11.4 | 12.2 | 3.5 |
| 5 | 5 | 1 | 66 | 6 | 20 | 0.8 | 11.4 | 12.2 | 0.8 |
| 6 | 2 | 2 | 66 | 6 | 20 | 0.8 | 11.4 | 12.2 | 0.8 |
| 7 | 2 | 3 | 66 | 6 | 20 | 0.8 | 11.4 | 12.2 | 0.8 |
| 8 | 2 | 4 | 66 | 6 | 20 | 0.7 | 20.5 | 21.2 | 0.8 |
| 9 | 2 | 5 | 66 | 6 | 20 | 0.7 | 20.5 | 21.2 | 0.8 |
| 10 | 2 | 6 | 66 | 6 | 20 | 0.4 | 11.5 | 11.9 | 0.8 |
| 11 | 2 | 7 | 66 | 6 | 20 | 3.2 | 11.1 | 14.3 | 0.8 |
| 12 | 2 | 8 | 66 | 6 | 20 | 11.6 | 10.2 | 21.8 | 0.8 |
| 13 | 2 | 9 | 66 | 6 | 20 | 0.9 | 6.1 | 6.9 | 0.8 |
| 14 | 2 | 10 | 66 | 6 | 20 | 0.7 | 21.6 | 22.4 | 0.8 |
| 15 | 2 | 11 | 39 | 3 | 20 | 0.8 | 11.4 | 12.2 | 0.8 |
| 16 | 2 | 12 | 50 | 5 | 20 | 0.8 | 11.4 | 12.2 | 0.8 |
| 17 | 2 | 1 | 66 | 6 | 20 | 0.8 | 11.4 | 12.2 | 0.8 |
| 18 | 6 | 1 | 66 | 6 | 20 | 0.8 | 11.4 | 12.2 | 0.8 |
| 19 | 7 | 1 | 66 | 6 | 20 | 0.8 | 11.4 | 12.2 | 0.8 |
| 20 | 8 | 1 | 66 | 6 | 20 | 0.8 | 11.4 | 12.2 | 0.8 |
| 21 | 3 | 13 | 66 | 6 | 20 | 10.4 | 19.5 | 29.9 | 3.0 |
| Comparative 1 | 2 | 14 | 20 | 1 | 20 | 0.8 | 11.4 | 12.2 | 0.8 |
| Comparative 2 | 9 | 1 | 66 | 6 | 20 | 0.8 | 11.4 | 12.2 | 0.8 |

TABLE 4-2

| | | | | | | | | Total | | | |
|---|---|---|---|---|---|---|---|---|---|---|---|
| | | | | Long | | | | amount of | | | |
| | | | Long | diameter/ | Primary | | | component | | Primary | |
| | | | diameter | short | particle | Amount of | Amount of | (a) and | Amount of | particle | Amount of |
| | | | of | diameter | diameter | component | component | component | component | diameter | component |
| | | Curable | compo- | of | of | (a) in | (b) in | (b) in | (e) in | of | (g) in |
| Exam- | Base | compo- | nent | compo- | component | surface | surface | surface | surface | component | surface |
| ple | Layer | sition | (a) | nent | (b) | layer | layer | layer | layer | (g) | layer |
| No. | No. | No. | [nm] | (a) | [nm] | [mass %] | [mass %] | [mass %] | [mass %] | [μm] | [mass %] |
| 101 | 2 | 1 | 66 | 6 | 20 | 0.8 | 11.4 | 12.2 | 0.8 | 2.0 | 0.5 |
| 102 | 2 | 1 | 66 | 6 | 20 | 0.8 | 11.4 | 12.2 | 0.8 | 2.0 | 0.8 |
| 103 | 2 | 1 | 66 | 6 | 20 | 0.8 | 11.4 | 12.2 | 0.8 | 2.0 | 2.0 |
| 104 | 2 | 1 | 66 | 6 | 20 | 0.8 | 11.4 | 12.2 | 0.8 | 3.0 | 0.5 |
| 105 | 2 | 1 | 66 | 6 | 20 | 0.8 | 11.4 | 12.2 | 0.8 | 3.0 | 0.8 |
| 106 | 2 | 1 | 66 | 6 | 20 | 0.8 | 11.4 | 12.2 | 0.8 | 3.0 | 2.0 |

In Table 4 and Table 4-2, the primary particle diameter of the component (b) is the number-average particle diameter of primary particles.

The amount of the component (a) is the content [mass %] of first particles in the surface layer.

The amount of the component (b) is the content [mass %] of second particles in the surface layer.

The total amount of the component (a) and the component (b) is the sum of the contents [mass %] of the first particles and the second particles in the surface layer.

In addition, the amount of the component (e) in the base layer is the sum of the contents [mass %] of cations and anions in the base layer.

In addition, the primary particle diameter of the component (g) is the number- average particle diameter of primary particle diameters, and the amount of the component (g) is the content [mass %] of particles in the base layer.

TABLE 5

| Example | Base | Curable | Presence of | Roughness | Adhesion to other |
|---|---|---|---|---|---|
| No. | layer No. | composition No. | heteroaggregation | Sa (μm) | members |
| 1 | 1 | 1 | Yes | 0.2 | A |
| 2 | 2 | 1 | Yes | 0.3 | A |
| 3 | 3 | 1 | Yes | 0.4 | A |
| 4 | 4 | 1 | Yes | 0.4 | A |
| 5 | 5 | 1 | Yes | 0.3 | A |
| 6 | 2 | 2 | Yes | 0.3 | A |
| 7 | 2 | 3 | Yes | 0.3 | A |
| 8 | 2 | 4 | Yes | 0.6 | A |
| 9 | 2 | 5 | Yes | 0.6 | A |
| 10 | 2 | 6 | Yes | 0.2 | A |
| 11 | 2 | 7 | Yes | 0.5 | A |
| 12 | 2 | 8 | Yes | 0.6 | A |
| 13 | 2 | 9 | Yes | 0.2 | A |
| 14 | 2 | 10 | Yes | 0.4 | A |
| 15 | 2 | 11 | Yes | 0.2 | A |
| 16 | 2 | 12 | Yes | 0.3 | A |
| 17 | 2 | 1 | Yes | 0.3 | A |
| 18 | 6 | 1 | Yes | 0.1 | A |
| 19 | 7 | 1 | Yes | 0.2 | A |
| 20 | 8 | 1 | Yes | 0.2 | A |
| 21 | 3 | 13 | Yes | 0.7 | A |
| Comparative 1 | 2 | 14 | No | 0.04 | B |
| Comparative 2 | 9 | 1 | No | 0.04 | B |

TABLE 5-2

| | | | | | | Height of | Width of | | Adhesion to |
|---|---|---|---|---|---|---|---|---|---|
| | | | | | Presence of | protrusion | protrusion | Number of | other |
| | | | | | protrusion | derived from | derived from | protrusions | members |
| | Base | Curable | | Roughness | derived from | base layer | base layer | derived from | (high contact |
| Example | Layer | composition | Presence of | Sa | base layer | particle | particle | base layer | pressure |
| No. | No. | No. | heteroaggregation | (μm) | particle | [μm] | [μm] | particle | condition) |
| 101 | 2 | 1 | Yes | 0.4 | Yes | 0.5 | 1.5 | 6 | A |
| 102 | 2 | 1 | Yes | 0.4 | Yes | 0.5 | 1.5 | 8 | A |
| 103 | 2 | 1 | Yes | 0.5 | Yes | 0.5 | 1.5 | 20 | A |
| 104 | 2 | 1 | Yes | 0.5 | Yes | 1.0 | 2.5 | 5 | A |
| 105 | 2 | 1 | Yes | 0.5 | Yes | 1.0 | 2.5 | 7 | A |
| 106 | 2 | 1 | Yes | 0.6 | Yes | 1.0 | 2.5 | 18 | A |

The long diameter and long diameter/short diameter of inorganic oxide particles constituting heteroaggregates and the number-average particle diameter of primary particles of the conductive metal oxide particles are as shown in Table 4 and Table 4-2.

In addition, in Examples 1 to 21 and Examples 101 to 104, the protruded portions derived from the heteroaggregates were confirmed. In Comparative Examples 1 and 2, the protruded portions derived from the heteroaggregates were not confirmed.

In addition, in Examples 101 to 104, the protruded portions derived from the base layer particles were confirmed. In Table 5-2, the number of protrusions derived from the base layer particles is the average number of the protruded portions in an area of 256 μm×192 μm.

According to at least one aspect of the present disclosure, it is possible to obtain an electrophotographic member that uses a material not PFAS-related and can restrict adhesion to other members. In addition, according to at least one aspect of the present disclosure, it is possible to obtain a method of producing an electrophotographic member that uses a material not PFAS-related and can restrict adhesion to other members. In addition, according to at least one aspect of the present disclosure, it is possible to obtain an electrophotographic image forming apparatus that can stably form high-quality electrophotographic images.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-124802, filed Jul. 31, 2024, and Japanese Patent Application No. 2025-071298, filed Apr. 23, 2025, which are hereby incorporated by reference herein in their entirety.

What is claimed is:

1. An electrophotographic member comprising a base layer and
a surface layer in direct contact with the base layer, wherein
the surface layer comprises heteroaggregates of first particles and second particles different from the first particles,
the first particles are
chain-like inorganic oxide particles,
the second particles comprise
a conductive metal oxide, and
a number-average particle diameter of primary particles of the second particles is 5 to 40 nm,
the surface layer has protruded portions derived from the heteroaggregates on an outer surface thereof opposite to a surface that faces the base layer,
an arithmetic mean height (Sa) of the outer surface is 0.1 to 0.7 μm,
the base layer comprises
at least one cation selected from the group consisting of cations represented by following Formulae (C1) to (C4) and
at least one anion selected from the group consisting of anions represented by following Formulae (A1) to (A4): 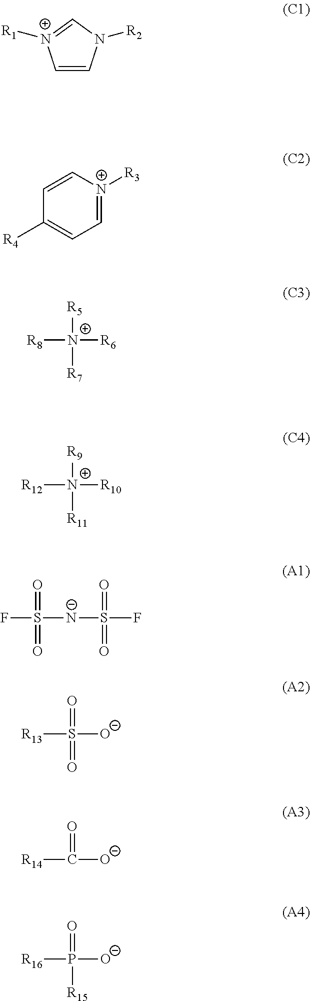
where,
R₁ to R₁₂ are each independently a hydrogen atom or a hydrocarbon group having 1 to 14 carbon atoms, provided that at least one selected from the group consisting of R₁ and R₂, at least one selected from the group consisting of R₃ and R₄, at least one selected from the group consisting of R₅ to R₈, and at least one selected from the group consisting of R₉ to R₁₂ are a linear or branched alkyl group having 1 to 14 carbon atoms, and
R₁₃ to R₁₆ are each independently a hydrogen atom, a hydrocarbon group having 1 to 18 carbon atoms, or an alkoxy group having 1 to 18 carbon atoms.

2. The electrophotographic member according to claim 1, wherein
a number average value of long diameters of the first particles is 30 to 100 nm, and
a number average value of a value ratio of long diameters to short diameters of the first particles (long diameter/short diameter) is 3 to 8.

3. The electrophotographic member according to claim 1, wherein the first particles are chain-like silica particles.

4. The electrophotographic member according to claim 1, wherein the second particles comprise at least one particle selected from the group consisting of zinc antimonate particles and antimony-doped tin oxide particles.

5. The electrophotographic member according to claim 1, wherein a sum of content of the first particles and content of the second particles in the surface layer, based on a mass of the surface layer, is 4.0 to 37.0 mass %.

6. The electrophotographic member according to claim 1, wherein content of the first particles in the surface layer, based on a mass of the surface layer, is 0.2 to 27.0 mass %.

7. The electrophotographic member according to claim 1, wherein content of the second particles in the surface layer, based on a mass of the surface layer, is 3.8 to 30.0 mass %.

8. The electrophotographic member according to claim 1, wherein a sum of content of the cations and content of the anions in the base layer, based on a mass of the base layer, is 0.4 to 3.5 mass %.

9. The electrophotographic member according to claim 1, wherein
the base layer comprises base layer particles, and
protruded portions derived from the base layer particles are present on the surface of the surface layer, the protruded portions derived from the base layer particles have a height of 0.1 to 5.0 μm and a width of 0.5 to 5.0 μm, and an average number of the protruded portions in an area of 256 μm×192 μm is 1 to 22.

10. The electrophotographic member according to claim 9, wherein a number-average particle diameter of the base layer particles is 1.5 to 3.5 μm.

11. The electrophotographic member according to claim 9, wherein the base layer particles are silicone particles.

12. The electrophotographic member according to claim 1, wherein the electrophotographic member is an intermediate transfer belt.

13. An electrophotographic image forming apparatus comprising the electrophotographic member according to claim 1 as an intermediate transfer belt.

14. A method of producing an electrophotographic member having a base layer and a surface layer in direct contact with the base layer,
the production method comprising:
preparing a base layer comprising component (e) below;
preparing a curable composition comprising component (a) to component (d) below;
forming a coating of the curable composition on one of surfaces of the base layer and drying the coating; and
curing the dried coating:
(a) first particles that are chain-like inorganic oxide particles;
(b) second particles that are different from the first particles, and have a number-average particle diameter of primary particles of 5 to 40 nm, and comprise a conductive metal oxide;
(c) (meth)acrylic monomers;
(d) at least one solvent selected from the group consisting of 2-butanone and 4-methyl-2-pentanone;
(e) a salt containing at least one cation selected from the group consisting of cations represented by following Formulae (C1) to (C4) and at least one anion selected from the group consisting of anions represented by following Formulae (A1) to (A4): 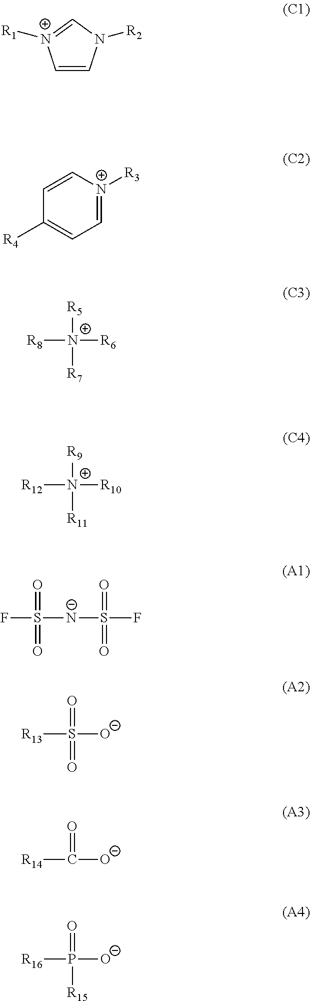
where
R₁ to R₁₂ are each independently a hydrogen atom or a hydrocarbon group having 1 to 14 carbon atoms, provided that at least one selected from the group consisting of R₁ and R₂, at least one selected from the group consisting of R₃ and R₄, at least one selected from the group consisting of R₅ to R₈, and at least one selected from the group consisting of R₉ to R₁₂ are a linear or branched alkyl group having 1 to 14 carbon atoms; and
R₁₃ to R₁₆ are each independently a hydrogen atom, a hydrocarbon group having 1 to 18 carbon atoms, or an alkoxy group having 1 to 18 carbon atoms.
